(19) United States
(12) Patent Application Publication
(10) Pub. No.: US 2007/0138092 A1
(43) Pub. Date: Jun. 21, 2007

(54) Method and system for controlling duration of a backwash cycle of a filtration system

(76) Inventors: Paul James Lever Smith, Castle Hill (AU); Saravanamuthu Vigneswaran, Castle Hill (AU); Huu Hao Ngo, Padstow (AU); Hung Nguyen, Castle Hill (AU); Roger Marcel Ben Aim, Layrac (FR)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/313,166

(22) Filed: Dec. 20, 2005

(51) Int. Cl. B01D 65/02

(52) U.S. Cl. 210/636; 210/741; 210/791; 210/321.69; 210/108

(57) ABSTRACT

A method of controlling duration of a backwash cycle of a filtration system commences with initiating pumping of a backwash fluid (12) through a filter (6) of the filtration system by way of a backwash pump (17). The flow rate of backwash fluid (12) is maintained to within 20% of a predetermined flow rate. A pressure sensor (23) takes a pressure measurement indicative of a pressure differential between upstream and downstream sides of the filter (6). Changes in the pressure measurement over time are monitored. A backwash duration controller (18) stops the backwash pump (17) when a rate of change of the pressure measurement reaches a predetermined minimum value.

### TECHNICAL FIELD

The present invention relates to the field of filtration systems, and particularly relates to a method and system for controlling filter backwash duration during operation of a filtration system.

### BACKGROUND OF THE INVENTION

As a consequence of increasingly stringent standards for wastewater disposal and re-use, membrane filtration has emerged as a promising new treatment technology. Such membrane systems are, however, subject to continued membrane fouling during operation. This has prevented the widespread application of this technology.

As the membrane filter becomes increasingly fouled, the permeability of the membrane declines, resulting in greater energy demands for the pumping systems driving or drawing the wastewater through the membrane to maintain a constant permeate flux (i.e. flow rate).

The foulant build up can be ameliorated by a periodic backwash, providing a flow of permeate in a reverse direction through the membrane filter. Such a backwash has been found to successfully remove most of the reversible component of the foulant layer, improving the permeability of the membrane so as to reduce the pressure drop across the membrane and permeate flux decline. Whilst the backwash is beneficial, it is only able to remove the reversible component of the foulant layer. During operation, however, part of the foulant layer, referred to as the “irreversible” component, becomes caked onto the membrane and is not able to be removed by backwashing. The level of irreversible foulant gradually increases over successive filtration/backwash cycles until the system eventually needs to be stopped for intensive physical and/or chemical cleaning of the membrane filter.

If a backwash cycle continues after the reversible component of the foulant deposition layer has been removed, the irreversible component of the foulant layer remains. Whilst a backwash of too long a duration is still effective in removing the reversible component of the foulant layer, the additional time and permeate used during the backwash unnecessarily reduces the productivity of the filtration system in terms of permeate production, and also increases the energy expended. A backwash of too short duration results in failure of the complete removal of the reversible component of the foulant layer.

An optimal backwash is thus one which terminates immediately after removal of the reversible component of the foulant layer. Whilst cake filtration theory has been used to determine optimal back flush durations, use of theory requires knowledge of various factors including the solids contents of the suspension, specific resistance of the foulant, viscosity of the suspension, the backwashing sweep efficiency, the backwash pressure factor and the fouling factor. Further, these factors rarely remain constant for any significant interval of production.

Statistical analyses have also been conducted to establish fixed backwash durations, however these fixed durations will only ever be optimal for a specific constant permeate flux and foulant concentration.

In practice, increased backwash duration is required as the level of fouling increases. Accordingly, fixed backwash durations are generally set at a level that is adequate for the last few backwash cycles prior to stopping the system for intensive cleaning. Such backwash durations are, however, excessive for early backwash cycles, resulting in productivity losses and excess energy usage.

### SUMMARY OF THE INVENTION

It is the object of the present invention to provide an improved method and system for controlling duration of a backwash cycle of a filtration system.

Yet another aspect of some embodiments of the present invention pertains to a method of controlling duration of a backwash cycle of a filtration system comprising:

initiating pumping of a backwash fluid through a filter of said filtration system,

maintaining a flow rate of said backwash fluid to within 20% of a predetermined flow rate,

taking a pressure measurement indicative of a pressure differential between upstream and downstream sides of said filter,

monitoring changes in said pressure measurement over time,

stopping said pumping of said backwash fluid when a rate of change of said pressure measurement reaches a predetermined minimum value.

In some embodiments, said flow rate of said backwash fluid is maintained substantially equal to said predetermined flow rate.

In some embodiments, said pressure measurement is a measurement of pressure in said backwash fluid at a location between said filter and a backwash pump pumping said backwash fluid through said filter.

In some embodiments, said pressure measurement is a direct measurement of pressure differential between said upstream and downstream sides of said filter.

In yet other embodiments, said predetermined minimum value is less than 1% of a change in said pressure measurement, since initiating pumping of said backwash fluid, per second. Typically, said rate of change of said pressure measurement is determined as an average rate over a predetermined time period.

In still other embodiments said filter is a membrane type filter.

There is further disclosed herein a backwash sub-system for a filtration system, said backwash sub-system comprising:

a backwash pump adapted to pump backwash fluid through a filter of said filtration system during a backwash cycle,

a backwash flow rate controller adapted to maintain a flow rate of said backwash fluid to within 20% of a predetermined flow rate during said backwash cycle,

a pressure sensor adapted to provide a pressure measurement indicative of a pressure differential between upstream and downstream sides of said filter,

means for monitoring changes in said pressure measurement over time,

a backwash duration controller configured to stop operation of said backwash pump when a rate of change of said pressure measurement reaches a predetermined minimum value.

In some embodiments, said backwash flow rate controller is adapted to maintain said flow rate of said backwash fluid to substantially equal to said predetermined flow rate during said backwash cycle.

In some embodiments, said pressure sensor is adapted to provide a measurement of pressure in said backwash fluid at a location between said backwash pump and said filter.

Alternatively, said pressure sensor is adapted to provide a direct measurement of said pressure differential between said upstream and downstream sides of said filter.

In yet other embodiments, said predetermined value is less than 1% of a change in said pressure measurement, since initiating pumping of said backwash fluid, per second.

### BRIEF DESCRIPTION OF THE DRAWINGS

Preferred forms of the present invention will now be described by way of example with reference to the accompanying drawings, wherein:

FIG. 1 is a schematic view of a filtration system according to one embodiment of the present invention.

FIG. 2 is a fragmentary perspective view of the filter of the filtration system of FIG. 1.

FIG. 3 depicts a generic profile or transmembrane pressure during a backwash cycle.

FIG. 4 is a flow diagram of a method of controlling duration of a backwash cycle.

FIG. 5 is a schematic view of a filtration system utilising an alternate configuration of pressure sensor according to another embodiment of the present invention.

### DETAILED DESCRIPTION OF THE PREFERRED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

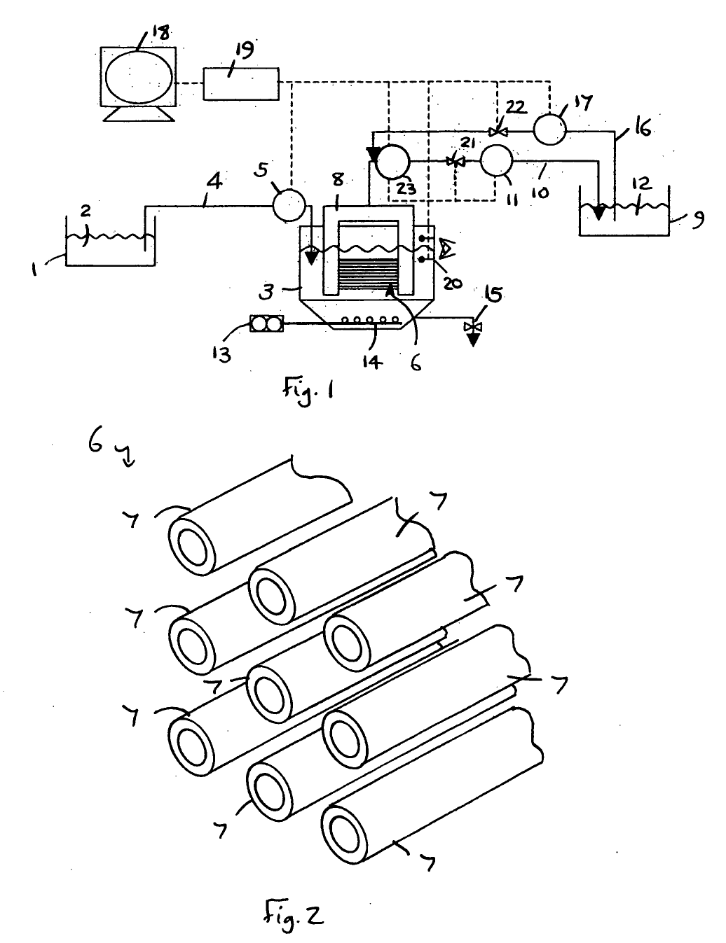

Referring to FIG. 1 of the accompanying drawings, a filtration system includes a feed tank 1 containing a supply of filtration feed material 2 (for example, waste water). The feed tank 1 is communicated with a reactor tank 3 by way of a feed conduit 4. The feed material 2 is pumped from the feed tank 1 into the reactor tank 3 by way of a feed pump 5 mounted in line with the feed conduit 4.

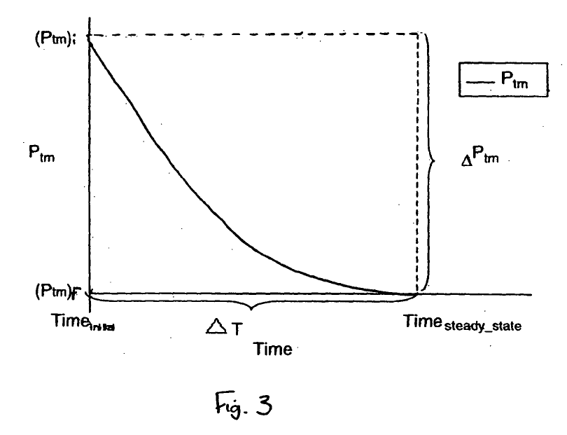

A filter 6, here in the form of a tubular type membrane assembly filter, is located within the reactor tank 3. As depicted in FIG. 2, the tubular type membrane assembly filter 6 consists of an array of parallel hollow fibre membranes 7. A suitable known such hollow fibre membrane is formed of polyethylene with wall pore sizes of approximately 0.1 μm, an inner bore diameter of 0.27 mm and outer diameter of 0.41 mm. In a test embodiment, a total of 320 such fibres each having a length of 12 cm were utilised, providing a total membrane surface area of 0.05 m². The opposing open ends of each of the fibre membranes communicate with a filter outlet manifold 8.

The filter outlet manifold 8 communicates with a permeate tank 9 via a permeate conduit 10. A suction type permeate pump 11 is mounted in line with the permeate conduit 10 to draw filtered permeate 12 (for example, filtered water) from the feed material 2 through the filter 6.

An air compressor 13 communicates with the base of the interior of the reactor tank 3 by way of an air diffuser 14, for supplying air to feed material 2 within the reactor tank 3, agitating the same. The air also assists in mixing feed material with powdered activated carbon (PAC) which may be added to the reactor tank 3 to adsorb organic matter in the feed material 2, reducing direct loading on the filter 6 and improving the level of total organics removal. The air also provides oxygen to assist biodegradation of organic matter in the feed material 2. Further, the air bubbles created in the feed material 2 assist in defouling of the membrane during the production cycle. A sludge drain 15 also communicates with the base of the interior of the reactor tank 3 for periodically draining contaminants extracted.

A backwash conduit 16 communicates the permeate tank 9 with the filter outlet manifold 8. A backwash pump 17 is mounted in line with the backwash conduit 16 for pumping filtered permeate 12 from the permeate tank 9 back through the filter 6 during a backwash cycle. Rather than utilising the permeate 12 as backwash fluid, alternate sources of backwash fluid (such as clean water from an alternate source) could be utilised as desired. The backwash pump 17 is here a constant flow rate pump, incorporating a backwash flow rate controller that endeavors to maintain a constant flow rate through the backwash pump 17. Rather than using an integral flow rate controller, a backwash flow rate control function could be carried out centrally by the filtration control system.

The filtration control system generally comprises a PC based Supervisory Control and Data Acquisition (SCADA) system 18 and programmable logic controller (PLC) 19. The SCADA system 18 is operationally connected to each of the feed pump 5, permeate pump 11 and backwash pump 17 via the PLC 19.

A floating reed switch 20 is mounted in the reactor tank and operationally communicates with the SCADA system 18 and PLC 19 so as to control the feed pump 5 to maintain a generally constant level of feed material 2 within the reactor tank 3.

A permeate solenoid valve 21 is mounted in line with the permeate conduit 10 between the filter outlet manifold 8 and the permeate pump 11 to enable/disable flow of permeate 12 from the filter outlet manifold 8 through the permeate pump 11. A backwash solenoid valve 22 is mounted in line with the permeate conduit 16 between the filter outlet manifold 8 and the backwash pump 17 to enable/disable backwash flow of permeate 12 from the backwash pump 17 into the filter manifold 8. Both the permeate solenoid valve 21 and backwash solenoid valve 22 operatively communicate with the SCADA system 18 and PLC 19.

A pressure sensor 23 is located at a position between the filter 6 and the backwash pump 17. Here the pressure sensor 23 is mounted in line either with the permeate conduit 10 or the backwash conduit 16, in a location between the filter manifold 8 and the respective solenoid valves 21, 22, such that the pressure sensor 23 communicates with both the permeate conduit 10 and backwash conduit 16 (and filter outlet manifold 8). This enables a measurement of pressure in the permeate during a backwash cycle and during a filtration production cycle, as will be discussed below.

In operation, the SCADA system 18 and PLC 19 control a filtration production cycle of the filtration system, pumping feed material 2 into the reactor tank 3 so as to maintain a generally constant level of feed material 2 in the reactor tank 3 based on feedback from the floating reed switch 20. The suction permeate pump 11 generates a pressure reduction in the filter outlet manifold 8 and within the hollow fibre membranes 7 of the filter 6, creating a pressure drop through the membranous walls of the hollow fibre membranes 7. This pressure drop draws feed material through the porous walls of the hollow fibre membranes 7, thereby filtering the feed material so as to produce filtered permeate 12, which is drawn through the permeate conduit 10 and into the permeate tank 9. As permeate 12 is drawn through the filter 6, foulant will become deposited on the walls of the hollow fibre membranes 7, gradually blocking the membrane pores.

The suction permeate pump 11 will typically be a constant flow rate pump. As the level of foulant build up increases, the resistance to flow of permeate through the filter 6 increases. An increased suction pressure is generated by the suction permeate pump 11 as a result, in an endeavour to maintain the constant permeate flow rate. A measurement of this pressure is taken by the pressure sensor 23. The pressure measurement provides an indication of the pressure differential between the upstream and downstream sides of the filter 6 (being the exterior and hollow interior of the hollow fibre membranes 7 respectively), given that the upstream side pressure in the reactor tank 3 will be generally constant, particularly as the floating reed switch 20 maintains a constant feed level within the reactor tank 3. This pressure differential or pressure drop is generally referred to as the transmembrane pressure (Pₜₘ).

To ameliorate the foulant build up, the SCADA system 18 and PLC 19 control initiation of a backwash cycle, stopping operation of the suction permeate pump 11, closing the permeate solenoid valve 21, opening the backwash solenoid valve 22 and initiating operation of the backwash pump 17. The backwash pump 17 pumps backwash fluid (in the form of permeate 12 in the permeate tank 9) through the backwash conduit 16 and filter outlet manifold 8 through the filter 6 in a reverse direction from the hollow bore of each of the hollow fibre membranes 7 into the reactor tank 3. Initiation of the backwash cycle commences removal of the reversible component of the foulant layer on the filter hollow fibre membranes 7.

Whilst the backwash flow rate controller of the backwash pump endeavors to maintain a constant flow rate of backwash fluid, the flow rate of backwash fluid may in practice increase slightly as the resistance to flow through the filter 6 reduces due to the reversible component of foulant layer being removed.

During the backwash cycle, the pressure sensor 23 provides a measurement of pressure in the backwash fluid 12 between the backwash pump 17 and the filter 6. This pressure is thus equal to the pressure on the upstream side of the filter 6 during the backwash cycle. As the pressure on the downstream side of the filter 6 during the backwash cycle will remain substantially constant (even through it may increase slightly as a result of the depth in the reactor tank 3 increasing slightly with the reverse flow of backwash fluid into the reactor tank), the pressure measurement taken by the pressure sensor is again indicative of the pressure differential between the upstream and downstream sides of the filter 6, that is, the transmembrane pressure (Pₜₘ).

The measurement of pressure provided by the pressure sensor 23 is communicated with the PLC 19 and SCADA system 18, which monitors changes in the pressure measurement over time.

FIG. 3 depicts a typical profile of the transmembrane pressure (Pₜₘ) during a backwash cycle. At the beginning of the backwash cycle, whilst the filter 6 has a significant degree of reversible membrane fouling, there is an initial transmembrane pressure (Pₜₘ)ᵢ that will vary depending on the level of fouling at the beginning of the backwash cycle. The present inventors have found that the transmembrane pressure decreases steadily during initial stages of the backwash cycle as the reversible component of the foulant is successfully removed by the backwashing As the filter becomes more clear, and the bulk of the reversible component of the foulant layer is removed, the rate of change of the transmembrane pressure gradually decreases asymptotically towards a final transmembrane pressure (Pₜₘ)_{f}, as again indicated in FIG. 3. This indicates that no further foulant material is being removed from the filter 6. If the backwash is continued beyond the time at which the transmembrane pressure effectively reaches a steady state, no further benefit is obtained. The only effects of continuing the backwash cycle is to waste production time and consume further energy. Also, the asymptotic nature of the transmembrane pressure profile indicates that the law of ever diminishing returns generally applies as the transmembrane pressure reaches the steady state.

The SCADA 18 acts as a backwash duration controller signalling to the backwash pump 17 via the PLC 19 to stop operation of the backwash pump when the rate of change of the pressure measurement reaches a predetermined minimum value. The predetermined minimum rate of change will typically be close to zero such that the maximum level of reversible foulant layer removal is achieved. A simple example control logic stops operation of the backwash pump 17 when there is no significant decrease in transmembrane pressure over a predetermined period, suitably a five second period.

A suitable specific control logic would be to stop backwash operation when the change in transmembrane pressure over a five second period reaches a value equal to or less than 2% of the total change in transmembrane pressure since initiation of the current backwash cycle. That is, if the transmembrane pressure at the end of a given five second period is (Pₜₘ)₂ and the transmembrane pressure at the beginning of the period is (Pₜₘ)₁, the backwash pump is stoped when the following equation is satisfied:
((Pₜₘ)₁−(Pₜₘ)₂)≦0.02×((Pₜₘ)ᵢ−(Pₜₘ)₂)
This equates to a rate of change of transmembrane pressure (average over the five second period) of:
0.4%×((Pₜₘ)ᵢ−(Pₜₘ)₂) per second.
For relatively clear backwash fluids, a lower rate approaching 1% pressure change over a five second period (0.2% per second) might be more appropriate, whereas for a more waste laden backwash fluid higher rates approaching 5% pressure change over a five second period (1% per second) might be appropriate.

The backwash duration control logic, based on the rate of change of transmembrane pressure, is most effective when the backwash flow rate is maintained at a constant level. As the reversible foulant layer is removed during the backwash cycle, reducing the resistance to backwash flow, the resistance may generally lead to a reduction in transmembrane pressure and/or an increase in backwash flow rate. If the backwash flow rate is maintained at a constant level, then the entire effect of the reduced resistance (resulting directly from the level of removal of irreversible foulant) will be reflected in the reduction in transmembrane pressure.

If, however, the backwash flow rate is also allowed to increase, then there will be a lower decrease in transmembrane pressure, with the transmembrane pressure dependant both on the level of irreversible foulant layer removal and the increase in backwash flow rate. Significant increases in backwash flow rate should thus be avoided such that there is at least a substantially direct correlation between the level of reversible foulant removal and the reduction in transmembrane pressure. The present inventors have found that a sufficiently direct correlation is maintained with increases (or even decreases) in backwash flow rates of up to 20% during the backwash cycle. Whilst changes in temperature of the backwash fluid may also have an effect on transmembrane pressure, these will generally be negligible.

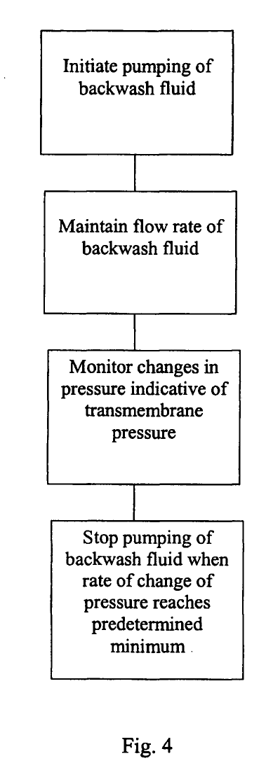

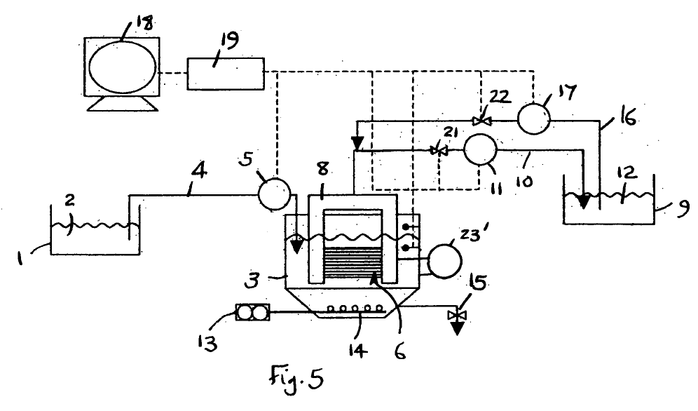

An overview of the entire backwash cycle according to one embodiment of the present invention is provided in FIG. 4.

When the backwash pump 17 is stopped to complete the backwash cycle, the backwash solenoid valve 22 is closed, the permeate solenoid valve 21 opened and the suction permeate pump 11 reactivated so as to initiate the next production cycle.

The production and backwash cycles are then repeated until a full system shutdown is required for intensive physical and/or chemical cleaning of the membrane filter to remove the build up in irreversible component of the foulant layer. A determination as to when the intensive cleaning of the filter is required may also be based on the transmembrane pressure, an indication of which is provided during each production cycle by the pressure sensor 23.

The method and control system described provides for backwash cycle durations of a just sufficient length to remove all or substantially all of the reversible component of membrane foulant, thereby providing productivity and energy usage improvements compared to fixed duration backwashes.

Rather than arranging the pressure sensor 23 to provide a measurement of pressure in the backwash fluid 12 between the backwash pump 17 and the filter 6 as discussed above, an alternate pressure sensor may be arranged to provide a direct measurement of the pressure differential between upstream and downstream sides of the filter 6. Such an arrangement is depicted in FIG. 5 with a pressure differential type pressure sensor 23′ communicating with fluid in the reactor tank 3 and with backwash fluid within the filter outlet manifold 8, providing a pressure differential between the two.

Other forms of filter are also envisaged. Particularly, other forms of membrane filters, such as single tubular membranes or flat plate membranes may be utilised. Further, other general forms of filters that are suitable for backwashing, including floating medium filters are envisaged. The person skilled in the art will appreciate other possible variations in filter type and other components of the system and method disclosed.

While the inventions have been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

1. A method of controlling duration of a backwash cycle of a filtration system comprising the:
initiating pumping of a backwash fluid through a filter of said filtration system,
maintaining a flow rate of said backwash fluid to within 20% of a predetermined flow rate,
taking a pressure measurement indicative of a pressure differential between upstream and downstream sides of said filter,
monitoring changes in said pressure measurement over time, and
stopping said pumping of said backwash fluid when a rate of change of said pressure measurement reaches a predetermined minimum value.

2. The method of claim 1 wherein said flow rate of said backwash fluid is maintained substantially equal to said predetermined flow rate.

3. The method of claim 1 wherein said pressure measurement is a measurement of pressure in said backwash fluid at a location between said filter and a backwash pump pumping said backwash fluid through said filter.

4. The method of claim 1 wherein said pressure measurement is a direct measurement of pressure differential between said upstream and downstream sides of said filter.

5. The method of claim 1 wherein said predetermined minimum value is less than 1% of a change in said pressure measurement, since initiating pumping of said backwash fluid, per second.

6. The method of any claim 1 wherein said rate of change of said pressure measurement is determined as an average rate over a predetermined time period.

7. The method of claim 1 wherein said filter is a membrane type filter.

8. A backwash sub-system for a filtration system, said backwash sub-system comprising:
a backwash pump adapted to pump backwash fluid through a filter of said filtration system during a backwash cycle,
a backwash flow rate controller adapted to maintain a flow rate of said backwash fluid to within 20% of a predetermined flow rate during said backwash cycle,
a pressure sensor adapted to provide a pressure measurement indicative of a pressure differential between upstream and downstream sides of said filter,
means for monitoring changes in said pressure measurement over time, and
a backwash duration controller configured to stop operation of said backwash pump when a rate of change of said pressure measurement reaches a predetermined minimum value.

9. The backwash sub-system of claim 8 wherein said backwash flow rate controller is adapted to maintain said flow rate of said backwash fluid to substantially equal to said predetermined flow rate during said backwash cycle.

10. The backwash sub-system of claim 8 wherein said pressure sensor is adapted to provide a measurement of pressure in said backwash fluid at a location between said backwash pump and said filter.

11. The backwash sub-system of claim 8 wherein said pressure sensor is adapted to provide a direct measurement of said pressure differential between said upstream and downstream sides of said filter.

12. The backwash sub-system of claim 8 wherein said predetermined value is less than 1% of a change in said pressure measurement, since initiating pumping of said backwash fluid, per second.

13. A backwash system for a filtration system, said backwash system comprising:
a backwash pump adapted to pump backwash fluid through a filter of said filtration system during a backwash cycle,
a backwash flow rate controller adapted to maintain a flow rate of said backwash fluid to within 20% of a predetermined flow rate during said backwash cycle,
a pressure sensor adapted to provide a pressure measurement indicative of a pressure differential between upstream and downstream sides of said filter, and
a backwash duration controller configured to stop operation of said backwash pump when a rate of change of said pressure measurement reaches a predetermined minimum value.

14. The backwash system of claim 13 wherein said backwash flow rate controller is adapted to maintain said flow rate of said backwash fluid to substantially equal to said predetermined flow rate during said backwash cycle.

15. The backwash system of claim 13 wherein said pressure sensor is adapted to provide a measurement of pressure in said backwash fluid at a location between said backwash pump and said filter.

16. The backwash system of claim 13 wherein said pressure sensor is adapted to provide a direct measurement of said pressure differential between said upstream and downstream sides of said filter.

17. The backwash system of claim 13 wherein said predetermined value is less than 1% of a change in said pressure measurement, since initiating pumping of said backwash fluid, per second.

18. The backwash system of claim 13 wherein said backwash pump is operably connected to at least one of said backwash flow rate controller or said backwash duration controller, said pressure sensor provides a signal corresponding to the pressure differential, and said backwash duration controller receives said signal and stops operation of said backwash pump in response thereto.

19. The backwash system of claim 13 which further comprises a digital controller operating a software algorithm, at least a portion of said back flow rate controller being represented in said algorithm and at least a portion of said backwash duration controller being represented in said algorithm.
